(19) United States
(12) Patent Application Publication
(10) Pub. No.: US 2012/0013460 A1
(43) Pub. Date: Jan. 19, 2012

(54) ENVIRONMENTAL ALARMS SENT VIA SMS TEXT MESSAGING

(76) Inventor: Gerard L. Cullen, Austin, TX (US)

(21) Appl. No.: 12/987,856

(22) Filed: Jan. 10, 2011

Related U.S. Application Data
(60) Provisional application No. 61/364,875, filed on Jul. 16, 2010.

(51) Int. Cl. G08B 1/08; G08B 21/00

(52) U.S. Cl. 340/539.11; 340/540

(57) ABSTRACT

One example embodiment includes a system for remotely conveying a deleterious condition of a controlled environment. The system includes a sensor, where the sensor is configured to produce a signal which indicates a measured value of an environmental condition in a controlled environment. The system also includes a monitoring unit. The monitoring unit is configured to receive the signal from the sensor, determine the value of the environmental condition and determine whether the value of the environmental condition exceeds predetermined boundaries. The system further includes an electronic circuit, where the electronic circuit is configured to transmit an alert message if the monitoring unit determines the value of the environmental condition exceeds the predetermined boundaries.

### CROSS-REFERENCE TO RELATED APPLICATIONS

This application claims the benefit of and priority to U.S. Provisional Patent Application Ser. No. 61/364,875 filed on Jul. 16, 2010, which application is incorporated herein by reference in its entirety.

### BACKGROUND OF THE INVENTION

Freezers, refrigerators or equivalent devices used to store perishable products are frequently situated remotely from the kitchen or other high traffic areas of a residence or business, such as, for example, in a storage area or basement, or are otherwise left unattended.

In the event of a freezer failure, it is important that the user take immediate steps to prevent the freezer's interior temperature from rising above a predetermined safe temperature which may cause loss of the contents stored therein. In the event of a power failure, the user may also be unaware of the situation.

A wide variety of temperature alarm devices exist. These alarms use many temperature sensing methods but the method of signaling the over-temperature or under-temperature alarms conditions are audible alarms, visual alarms, telephone alarms and building security systems.

Visual and audible temperature alarms have the shortcoming of limited range. Flashing lights, horns, and gauge-type indicators are typical. These alarm indicators require a human presence to know of the failure, but many freezers are left unattended in the evening hours or on weekends. Failure of the refrigeration equipment during these periods may cause the freezer contents to be ruined. Alternatively, the user may be forced to hire security or other personnel to monitor the alarms, a significant expense.

Building security systems may be modified to add a temperature sensor in the same manner as a window position sensor. Substituting a temperature sensor for a door or window switch, or a pressure sensitive switch, may enable use of an alarm circuit as a burglar alarm or a pump failure alarm. The disadvantage of this approach is the cost and complexity of the basic system and the cost of installation and modifications to the system.

Telephone-based alarm systems solve the distance problem but add the extra monthly cost of a telephone line. Additionally, the failure of the telephone line or the failure of city power can leave the telephone-based alarm system useless unless the telephone alarm system has battery back-up. This approach uses circuitry to automatically dial a phone number and play pre-recorded messages that describe the alarm condition to the person who answers the phone. The disadvantage of this approach is the monthly subscription cost of a telephone line and the possibility that the call will not be answered.

The widespread availability of Internet-based communications provides a means for the alarm sensing mechanisms to cause an e-mail or other type of text message to be created. However, these systems may require a high level of technical skill to install and maintain the complex system. Additionally, it requires the cost of an Internet connection, an e-mail service provider and the expense of maintaining the equipment and related network software as well as the alarm mechanism. Additionally, the user is now required to have network-trained personnel periodically test system operation.

There is, therefore, a need for a simple, easily installed and maintained temperature alarming method which is inexpensive, easily used by non-technical personnel, has a low cost of operation, and has no distance limitations.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for remotely conveying a deleterious condition of a controlled environment. The system includes a sensor, where the sensor is configured to produce a signal which indicates a measured value of an environmental condition in a controlled environment. The system also includes a monitoring unit. The monitoring unit is configured to receive the signal from the sensor, determine the value of the environmental condition and determine whether the value of the environmental condition exceeds predetermined boundaries. The system further includes an electronic circuit, where the electronic circuit is configured to transmit an alert message if the monitoring unit determines the value of the environmental condition exceeds the predetermined boundaries.

Another embodiment includes a system for remotely conveying a deleterious condition of a controlled environment. The system includes a sensor, where the sensor is configured to produce a signal which indicates a measured value of an environmental condition in a controlled environment. The system also includes a monitoring unit where the monitoring unit is located externally to the enclosed room. The monitoring unit includes an electronic display and a control element. The control element is configured to allow a user to adjust the environmental condition to be monitored and allow the user to adjust the value of predetermined boundaries. The monitoring unit is configured to receive the signal from the sensor, determine the value of the environmental condition and determine whether the value of the environmental condition is outside of the predetermined boundaries. The system further includes an electronic circuit, where the electronic circuit is configured to transmit an alert message if the monitoring unit determines the value of the environmental condition exceeds the predetermined boundaries.

Another embodiment includes a system for remotely conveying a deleterious condition of a controlled environment. The system includes a sensor, where the sensor is configured to produce a signal which indicates a measured value of an environmental condition in a controlled environment. The system also includes a monitoring unit where the monitoring unit is located externally to the enclosed room. The monitoring unit includes an electronic display and a control element. The control element is configured to allow a user to adjust the environmental condition to be monitored and allow the user to adjust the value of predetermined boundaries. The monitoring unit also includes a keypad, where the keypad is configured to allow the user to enter information. The monitoring unit is configured to receive the signal from the sensor, determine the value of the environmental condition and determine whether the value of the environmental condition is outside of the predetermined boundaries. The system further includes an electronic circuit, where the electronic circuit is configured to transmit an alert message if the monitoring unit determines the value of the environmental condition exceeds the predetermined boundaries.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a system for environmental control monitoring;

FIG. 2 illustrates an example of a monitoring unit;

FIG. 3 illustrates an example of a user remotely configuring a monitoring system;

FIG. 4 is a flowchart illustrating an example of a method for testing a SIM card for preexisting text message traffic;

FIG. 5 is a flow chart illustrating an example of a method for allowing a user to modify the monitoring settings of a monitoring unit;

FIG. 6 is a flowchart illustrating an example of a method for providing a regular status report to a user; and

FIG. 7 illustrates an example of a system for providing alerts to multiple users.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

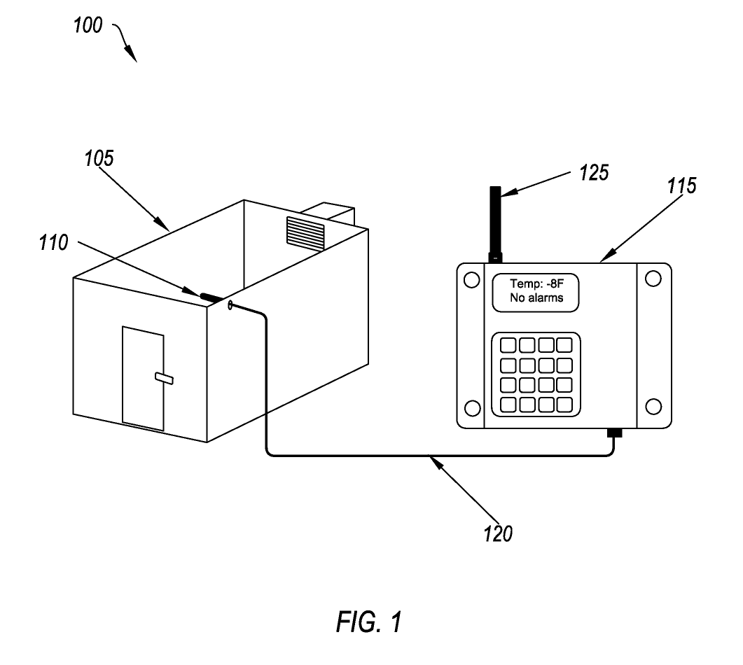

FIG. 1 illustrates an example of a system 100 for environmental control monitoring. In at least one implementation, the system 100 can monitor the environment and produce an alert if the monitored parameters pass beyond certain boundaries. Parameters can include humidity, temperature, chemical composition or any other environmental condition that the user seeks to keep within set boundaries. For example, if the if the temperature gets too hot or too cold, the system 100 can provide an alert to a user or users who can then correct any errors, as discussed below.

FIG. 1 shows that the system 100 can include an enclosed room 105. In at least one implementation, the enclosed room 105 can include a space used to provide a controlled storage environment. For example, the enclosed room 105 can include a walk in refrigerator, a freezer, a lab or any other controlled environment. For example, the enclosed room 105 can be used to ensure that the environment includes a certain chemical composition. I.e., the enclosed room 105 can be used to ensure that the environment retains a low oxygen atmosphere or that the environment remains within any other boundaries set by the user.

FIG. 1 also shows that the system 100 can include a sensor 110. In at least one implementation, the sensor 110 is mounted or otherwise placed in the enclosed room 105. The sensor 110 can be used to monitor the parameters that the user seeks to control. For example, the sensor 110 can measure the temperature of the enclosed room 105. Additionally or alternatively, the sensor 110 can monitor the composition of the atmosphere, the humidity or any other parameter.

In at least one implementation, the sensor 110 can include a device that measures a physical quantity and converts it into a signal which can be read by an observer or by an instrument. For example, the sensor 110 can include a thermocouple that converts temperature to an output voltage which can be read by a voltmeter. In particular, the sensor 110 can include a device which receives and responds to a signal. I.e., the sensor 110 changes its output signal based on changes in the parameter being measured. The sensitivity of the sensor 110 is an indication of how much the sensor's output changes when the measured quantity changes. For instance, if the mercury in a thermometer moves 1 cm when the temperature changes by 1° C., the sensitivity is 1 cm/° C. Ideal sensors are designed to be linear or linear to some simple mathematical function of the measurement, typically logarithmic.

FIG. 1 further shows that the system 100 can include a monitoring unit 115. In at least one implementation, the monitoring unit 115 can be mounted externally to the enclosed room 105. By mounting the monitoring unit 115 external to the enclosed room 105 personnel can view parameters and make adjustments without changing the environment in the enclosed room 105. I.e., the personnel need not enter the enclosed room 105, potentially causing disruptions in the controlled environment, in order to make changes to the environment within the enclosed room 105.

FIG. 1 also shows that the monitoring unit 115 can be connected to the sensor 110 using a cable 120 or other communication means. In at least one implementation, the cable 120 can pass through the exterior of the enclosed room 105. The area around the cable 120 can be insulated or otherwise configured to ensure that the controlled environment within the enclosed room 105 remains stable, even while allowing the cable 120 to pass electronic signals into and out of the enclosed room 105.

FIG. 1 further shows that the system 100 can include an antenna 125. In at least one implementation, the antenna 125 can be connected to the monitoring unit 115. The antenna 125 can include a cellular network antenna or any other antenna for sending and receiving electronic signals. The antenna 125 can be used to transmit a status report to selected personnel, as described below. For example, if the monitored parameter passes the boundaries set by the monitoring unit 115, an alert can be sent which includes information about the parameter that is not in the desired range. The antenna 125 can be located in an area of good reception in order to ensure that the alert can be sent. In contrast, the enclosed room 105 can include a metal exterior or other insulation that reduces the reception inside the enclosed room.

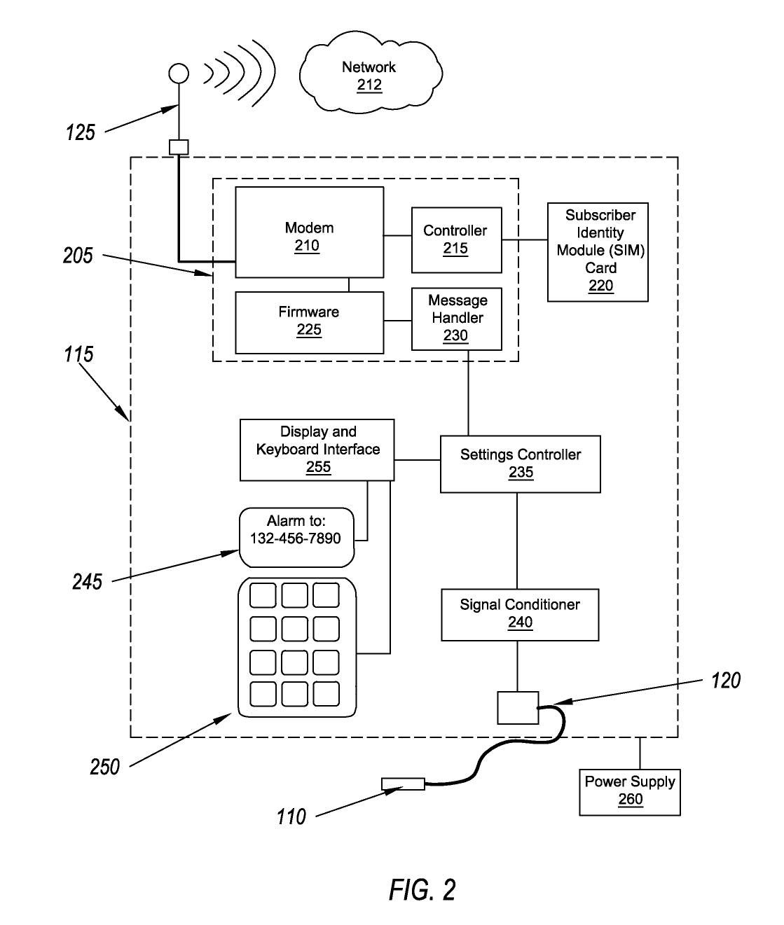

FIG. 2 illustrates an example of a monitoring unit 115. In at least one implementation, the monitoring unit 115 allows a user to select environmental parameters to monitor within a controlled environment. If the parameter goes above or below accepted levels the monitoring unit can send an alert to selected personnel, as described below.

FIG. 2 shows that the monitoring unit 115 can include a messaging circuit 205. In at least one implementation, the messaging circuit 205 can allow the monitoring unit 115 to send and receive messages about the status of the controlled environment. For example, the messaging circuit 205 can send or receive a short message system (“SMS”) text message regarding the status of the controlled environment. The global average price for an SMS message is 0.11 USD; and may not require monthly subscription fees; therefor, the alert can be sent for relatively low cost. Additionally or alternatively, the messaging circuit 205 can send or receive an email, a tweet or any other message to or from the selected personnel, as described below.

In at least one implementation, SMS is the text communication service component of phone, web or mobile communication systems. SMS can include standardized communications protocols that allow the exchange of short text messages between fixed or mobile devices. In at least one implementation, the protocol can include a global system for mobile communications (“GSM”) protocol. GSM can include a cellular network that allows mobile phones or other mobile devices to connect by searching for cells in the immediate vicinity.

FIG. 2 shows that the messaging circuit 205 can include a modem 210. In at least one implementation, the modem 210 includes an electronic device that makes possible the transmission of data via telephone or other communication lines. For example, the modem 210 can include a device that modulates an analog carrier signal to encode digital information. In particular, the modem 210 can transmit an alert using the antenna 125 to connect to the network 212.

FIG. 2 also shows the messaging circuit 205 can include a controller 215. In at least one implementation, the controller 215 can instruct the modem 210 in connecting the messaging circuit 205 to a cellular network. For example, the controller 215 can broadcast, via the modem 210, the correct information needed to connect to the network 212 so that the desired message can be broadcast.

FIG. 2 further shows that the monitoring unit 115 can include a subscriber identity module (“SIM”) card 220. In at least one implementation, a SIM card 220 can securely store the international mobile subscriber identity (“IMSI”—aka service-subscriber key) used to identify a subscriber on the network 212. For example, the SIM card 220 can contains a unique serial number, internationally unique number of the mobile user, security authentication and ciphering information, temporary information related to the network 212, a list of the services the user has access to and two passwords (personal identification number (“PIN”) for usual use and pin unlock code (“PUK”) for unlocking the SIM card if the wrong PIN is entered).

In at least one implementation, the controller 215 can interact with the SIM card 220 when the monitoring unit 115 needs to connect to the network. In particular, the controller 215 can access the information stored on the SIM card 220. The controller 215 can then connect to the network 212 via the modem 210. I.e., the controller 215 can prepare the data needed to connect the modem 210 to the network 212 so that the desired message can then be sent over the network 212, as described below.

FIG. 2 also shows that the messaging circuit 205 can include SMS data protocol firmware 225. In at least one implementation, the firmware 225 can be used to denote the fixed programs and/or data structures that internally control the messaging circuit 205. I.e., the firmware 225 can include software which controls the very basic low-level operations without which the messaging circuit would not be functional.

FIG. 2 further shows that the messaging circuit 205 can include a message handler 230. In at least one implementation, the message handler 230 composes the message to be sent. I.e., the message handler 230 prepares a message to be transmitted to the selected personnel over the network.

FIG. 2 also shows that the monitoring unit 115 can include a settings controller 235. In at least one implementation, the settings controller 235 can execute a software control program regarding the controlled environment. The software can be executed in a microprocessor or can use the internal processor in the messaging circuit 205. In particular, the settings controller 235 can allow the user to select the parameters to measure and the acceptable range of values for the parameter to vary within. For example, the settings controller 235 can receive a message from the selected personnel, via the messaging circuit 205 or a control panel, which changes the parameters or ranges. Additionally or alternatively, the settings controller 235 can determine if the controlled environment has left the acceptable range of values and whether a message needs to be sent to the selected personnel.

FIG. 2 further shows that the monitoring unit 115 can include a cable 120. In at least one implementation, the cable 120 can allow the monitoring unit 115 to connect to a sensor 110. I.e., the connector can allow the monitoring unit 115 to receive an electronic signal from the sensor 110 indicating the status of the controlled environment. One of skill in the art will appreciate that the cable 120 can include any connector meant to receive an electronic signal from the sensor 110 wired or wireless, digital or analog.

FIG. 2 also shows that the monitoring unit 115 can include a signal conditioner 240. In at least one implementation, the signal conditioner 240 can receive the electronic signal from the sensor 110 and convert it to a format which can be interpreted by the settings controller 235. For example, the signal conditioner 240 can include a digital to analog converter or analog to digital converter. Additionally or alternatively, the signal conditioner 240 can increase or reduce the signal power.

FIG. 2 further shows that the monitoring unit 115 can include an electronic display 245. In at least one implementation, the electronic display 245 can include any display device for presentation of information for visual, tactile or auditive reception, acquired, stored, or transmitted in electronic form. In particular, an electronic display 245 is a device that receives an electronic signal as input and converts the electronic signal to a sensory signal that can be received by a user. For example, an electronic display 245 can include a television set, a computer monitor, a video display panel, a projector, a liquid crystal display (“LCD”), a light emitting diode (“LED”) display or speaker. One of skill in the art will appreciate that the electronic display 245 can include any device that converts an electronic signal into a sensory signal unless otherwise stated in the specification or the claims.

FIG. 2 also shows that the monitoring unit 115 can include a keypad 250. In at least one implementation, the keypad 250 can allow a user to enter data. For example, the keypad 250 can allow the user to select the parameter to be monitored and/or the ranged of acceptable values. Additionally or alternatively, the keypad 250 can allow the user to enter contact information for the personnel to be contacted if the monitored parameter passes beyond the acceptable boundaries. The keypad 250 can include physical keys or virtual keys shown on a touch screen. I.e., the electronic display 245 can include a touch screen which displays the keypad 250 as needed.

FIG. 2 further shows that the monitoring unit 115 can include an interface 255. In at least on implementation, the interface 255 connects the electronic display 245 and the keypad 250 to the settings controller 235. In at least one implementation, the interface 255 can convert the input from the keypad 250 to instructions for the settings controller 235. Additionally or alternatively, the interface 255 can convert the instructions in the settings controller 235 to be shown on the electronic display 245.

FIG. 2 also shows that the monitoring unit 115 can include a power source 260. In at least one implementation, the power source 260 can provide power to the monitoring unit 115 in order to allow the monitoring unit 115 to perform the desired functions. For example, the power source 260 can provide power which is used to control the monitoring unit 115, power the sensor 110 and allow the antenna 125 to send and receive messages as desired.

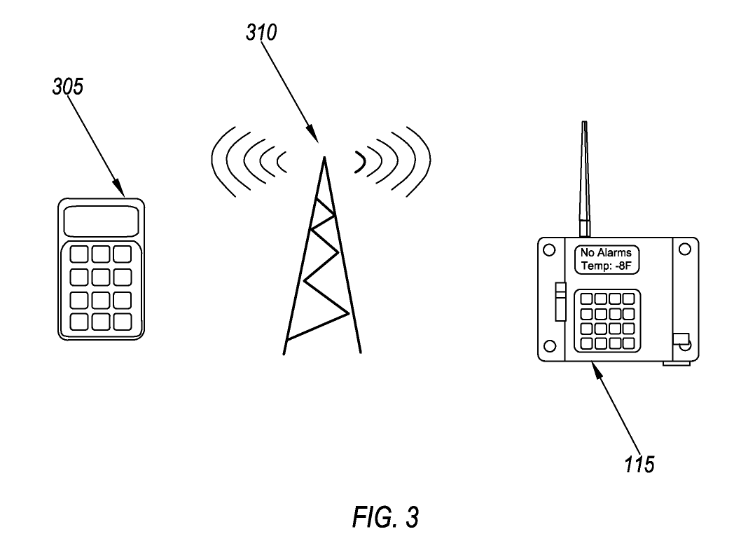

FIG. 3 illustrates an example of a user remotely configuring a monitoring unit 115. In at least one implementation, remote settings can allow a user to change the environmental conditions without having to be near the area where the environment is being controlled. This can allow the monitoring unit 115 to be adjusted without using a keypad and display. Additionally or alternatively, remote settings can allow a single individual or group of individuals to maintain control of the controlled environment. I.e., it can allow a an individual or group to remain in charge of the settings regardless of which personnel are physically near the monitoring unit 115.

FIG. 3 shows that the user can connect to the monitoring unit 115 using a cell phone 305 or other mobile device. In particular, the user can either connect to the monitoring unit 115 over a cellular network 310 or other network, as described above. Additionally or alternatively, the user can send an SMS text message over the cellular phone network 310 which include the instructions to the monitoring unit 115.

For example, the user can prepare an SMS text message on the cell phone 305 to invoke changes. The SMS text message can include only changes to the current settings or can include all settings as they will be in final form. For example, the SMS text message can instruct the monitoring unit 115 to change the upper allowed temperature to five degrees Fahrenheit. Additionally or alternatively, the SMS text message can instruct the monitoring unit 115 to monitor the temperature and the humidity of the environment and send an alert if the temperature goes below negative five degrees Fahrenheit or above five degrees Fahrenheit or the humidity goes below five percent or over ten percent. One of skill in the art will appreciate that remote settings can be allowed to change any of the settings or only a portion thereof, as desired by the user.

In at least one implementation, the monitoring unit 115 can send a return message to obtain authorization. For example, the monitoring unit 115 can send a return message to the sending cell phone 305 requesting an authorization code. Additionally or alternatively, the monitoring unit 115 can send a message to a predetermined cell phone or cell phones for authorization. The monitoring unit 115 can send a return message confirming the changes and/or the settings.

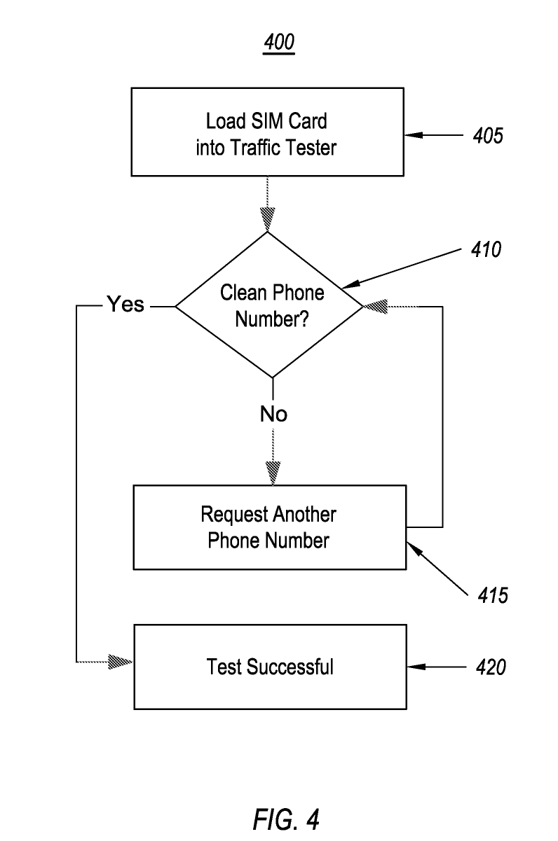

FIG. 4 is a flowchart illustrating an example of a method 400 for testing a SIM card for preexisting text message traffic. In at least one implementation, the method 400 can be used to for connecting the monitoring unit to a cellular network or to a particular carrier in order to test the SIM card. Additionally or alternatively, the method 400 can be used to ensure that the unit will not receive text messages from unknown sources which could disrupt the monitoring done by the monitoring unit. One of skill in the art will appreciate that the method 400 can be used to test the system 100 of FIG. 1; however, the method 400 can be used to test a system other than the system 100 of FIG. 1.

FIG. 4 shows that the method 400 includes loading the SIM card into a traffic tester 405. The SIM card is prepared by a cellular carrier and can contain the assigned phone number, account information, and a registration authorization code. Additionally or alternatively, the SIM card can include accompanying web-accessed user access for the user to add money to cover messaging fees. In addition, the SIM card can have voice privileges negated such that the SIM card can be used for SMS text messaging only and cannot receive incoming calls.

In at least one implementation, the traffic tester is configured to ensure that the phone number stored on the SIM card is free of previous traffic or restrictions. I.e., SIM card numbers are reused and a testing function is used to check that the former user has not subscribed to automatic SMS message feeds which could continue to send SMS messages. In particular, the SMS message feed may incur inbound message fees or may cause the settings to be changed in undesirable ways. In at least one implementation, the traffic tester begins by establishing radio contact with a cell phone tower. The unit then registers using the account information stored on the SIM card. If no contact is made, the display shows an error message.

FIG. 4 shows that the method 400 can include determining if the phone number is clean 410. I.e., if contact is made with the cell phone tower, then the SIM card can be monitored for a period of time to ensure that inbound messages are not received. For example, the SIM card can be monitored for 24 hours or for some other period of time. If no traffic is received, the SIM card is ready for use in a monitoring unit. Additionally or alternatively, the customer can buy the SIM card from the carrier with an assurance that the SIM card and/or phone number has not been previously used and forego the test for existing text traffic.

FIG. 4 also shows that the method 400 can include requesting another phone number 415 if the SIM card fails the test. For example, if the phone number receives more than a predetermined number of text messages within the test period the SIM card can fail the test. The phone number can be requested from the original carrier or can be requested from another carrier.

FIG. 4 further shows that the method 400 can include deeming the test successful 420 if the SIM card does not receive unanticipated text messages during the testing period. In at least one implementation, the SIM card can be required to receive no unanticipated text messages in order for the test to be successful. Additionally or alternatively, there can be a certain threshold under which the number of unanticipated text messages must remain for the test to be successful. For example, the SIM card can be allowed a single unanticipated text message in order to be considered successful.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

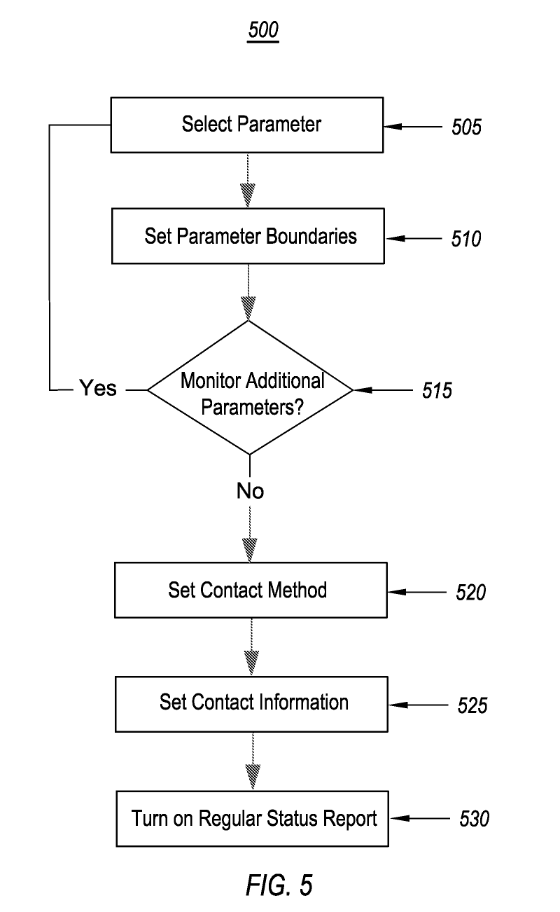

FIG. 5 is a flow chart illustrating an example of a method 500 for allowing a user to modify the monitoring settings of a monitoring unit. In at least one implementation, the method 500 can allow the user to select the parameters to be measured and the acceptable ranges of the measured parameters within a controlled environment.

FIG. 5 shows that the method 500 can include selecting the parameter to monitor 505. In at least one implementation, the parameter to monitor can include any condition of the controlled environment. For example, the parameter can include temperature, humidity, light level, chemical composition or any other parameter that the user desires to monitor, as described above.

FIG. 5 also shows that the method 500 can include setting the parameter boundaries 510. In at least one implementation, the parameter boundaries can include a lower boundary and an upper boundary. Additionally or alternatively, the parameter boundaries can include only an upper or lower limit. For example, the user may desire to monitor temperature in a freezer. The user may not desire the selected personnel to receive an alert if the freezer goes below the desired temperature but may desire an alert if the freezer goes above a certain temperature.

FIG. 5 further shows that the method 500 can include determining if additional parameters should be monitored 515. In at least one implementation, the controlled environment can include multiple parameters that the user wishes to monitor. For example, in museum clean rooms, the user may desire to control the temperature, humidity and light level of the clean room. Monitoring multiple parameters simultaneously can allow the user to have an alert sent if any of the desired parameters passes beyond the desired boundaries.

FIG. 5 also shows that the method 500 can include setting the contact method 520. In at least one implementation, the contact type can include any desired method of contacting selected personnel when an alert is required. For example, the contact method can include email, Twitter, text messages or any other method of contact. One of skill in the art will appreciate that setting the contact method 520 can include setting multiple contact methods. I.e., the user can select multiple contact methods, if desired.

FIG. 5 further shows that the method 500 can include setting the contact information 525. In at least one implementation, the contact information can include the contact information for the personnel to be contacted in the event that the measured parameter passes beyond the range of acceptable values. For example, the contact information can include the phone number of the selected personnel, the email address of the selected personnel, the Twitter account to which the alert will be sent or any other desired contact information. One of skill in the art will appreciate that setting the contact information 525 can include entering multiple addresses. I.e., the user can select multiple personnel to be contacted, if desired.

FIG. 5 also shows that the method 500 can include turning on regular status reports 530. In at least one implementation, regular status reports can include a message to the selected personnel at predetermined intervals regarding the status of the controlled environment. For example, the selected personnel can receive a status message each day at noon or at any other desired interval. The status report can include the parameter being monitored, the current value, the set boundaries, the personnel to be contacted or any other desired information.

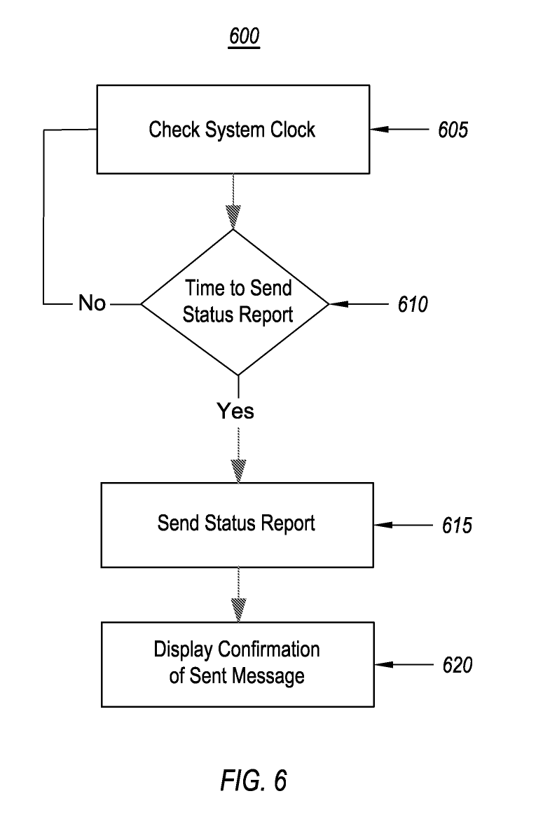

FIG. 6 is a flowchart illustrating an example of a method 600 for providing a regular status report to a user. In at least one implementation, the regular status report can provide the user with an assurance that the unit is functioning and able to successfully send messages.

FIG. 6 shows that the method 600 can include checking the system clock 605. In at least one implementation, the system can be configured to check the system clock 605 or a regular basis to ensure that status reports are sent as often as desired by the user. Additionally or alternatively, the system can monitor the time or otherwise set an alert such that the regular status report is sent at the predetermined time.

FIG. 6 also shows that the method 600 can include determining if it is time to send a status report 610. In at least one implementation, determining if is time to send a status report 610 can include comparing the current time to the time at which the status message should be sent. Additionally or alternatively, determining if it is time to send a status report can include determining the amount of time that passed since the last status message was sent.

FIG. 6 further shows that the method 600 can include sending the status message 615 if it is time to send the status message. In at least one implementation, a different status message can be sent to different personnel. I.e., the messages to each recipient can be composed individually. Additionally or alternatively, a single message can be composed which is sent to each recipient, either collectively or individually.

FIG. 6 also shows that the method 600 can include displaying confirmation of a sent message 620. In at least one implementation, displaying confirmation of a sent message 620 can confirm to a user near the monitoring unit that messages are being sent as needed. For example, as the user is setting the unit for monitoring, the user can have a status report sent, which can confirm that the unit is sending reports and alarms correctly.

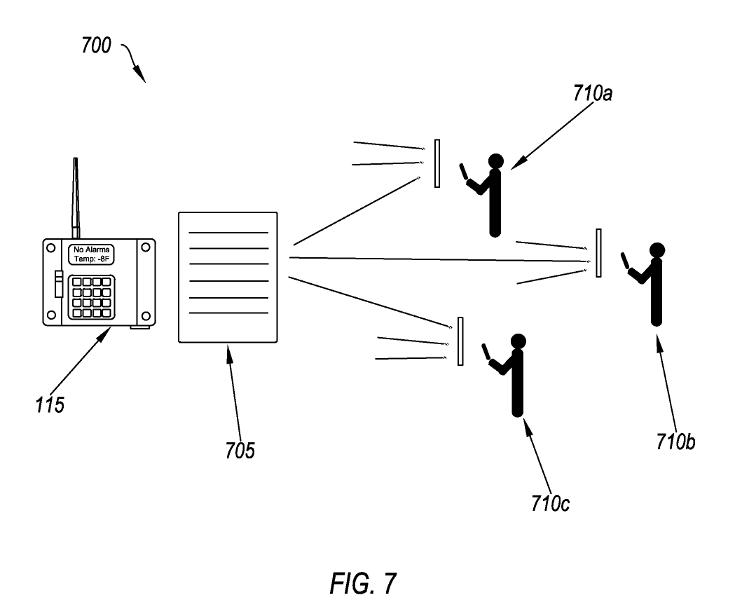

FIG. 7 illustrates an example of a system 700 for providing alerts to multiple users. In at least one implementation, the system 700 can include a monitoring unit 115 which sends the proper messages to a social networking application. For example, the monitoring unit 115 can post messages to Facebook, Twitter or some other social networking application.

FIG. 7 shows that the monitoring unit 115 can post an alert on the social networking application 705. In at least one implementation, the posting can be done via text message. Additionally or alternatively, the posting can occur via email, internet connection or any other accepted method of posting to the social networking application 705. Once the alert has been posted, the social networking application 705 can automatically forward the message as desired.

FIG. 7 also shows that the system 700 can include multiple followers 710a, 710b and 710c (collectively “followers 710”). In at least one implementation, the use of a social networking application 705 as a method of communication for the monitoring unit 115 provides lower operating costs and self-managed capability. For example, when an account is established with the social networking application 705 for the monitoring unit 115, it can have a large number of followers 710. The monitoring unit can post an alert to its account and multiple followers 710 will receive the alert simultaneously. Additionally or alternatively, the social networking application 705 may allow the alert to be “pushed” to the followers 710. I.e., the followers 710 can receive an indication that the alert was posted to the account.

In at least one implementation, typical followers 710 could be company management, repair personnel or route delivery drivers. Since followers 710 can individually elect to “follow” or “not follow” there is no need to change the parameters of the temperature alert. Additionally, because the social networking application 705 will forward messages for free, there are no additional transmit fees charged to the monitoring unit.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for remotely conveying a deleterious condition of a controlled environment, the system comprising:
a sensor, wherein the sensor is configured to produce a signal which indicates a measured value of an environmental condition in a controlled environment;
a monitoring unit, wherein the monitoring unit is configured to:
receive the signal from the sensor;
determine the value of the environmental condition; and
determine whether the value of the environmental condition exceeds predetermined boundaries; and
an electronic circuit, wherein the electronic circuit is configured to transmit an alert message if the monitoring unit determines the value of the environmental condition exceeds the predetermined boundaries.

2. The system of claim 1, wherein the alert message is a text message.

3. The system of claim 2, wherein the text message is a short messaging service text message.

4. The system of claim 1, wherein the alert message is an email.

5. The system of claim 1, wherein the alert message is transmitted via a social networking application.

6. The system of claim 5, wherein the social networking application is Twitter.

7. The system of claim 5, wherein the social networking application is Facebook.

8. The system of claim 1, wherein the electronic circuit is configured to transmit the status message via the Internet.

9. The system of claim 1, wherein the electronic circuit is configured to transmit the status message via a cellular network.

10. A system for remotely conveying a deleterious condition of a controlled environment, the system comprising:
a sensor, wherein the sensor is configured to produce a signal which indicates a measured value of an environmental condition in an enclosed room, wherein the enclosed room includes a controlled environment;
a monitoring unit, wherein the monitoring unit:
is located externally to the enclosed room; and
includes:
an electronic display; and
a control element, wherein the control element is configured to:
allow a user to adjust the environmental condition to be monitored; and
allow the user to adjust the value of the predetermined boundaries; and
is configured to:
receive the signal from the sensor;
determine the value of the environmental condition; and
determine whether the value of the environmental condition is outside of the predetermined boundaries; and
an electronic circuit, wherein the electronic circuit is configured to transmit an alert message if the monitoring unit determines the value of the environmental condition exceeds the predetermined boundaries.

11. The system of claim 10, wherein the electronic circuit is further configured to receive an incoming message.

12. The system of claim 11, wherein the incoming message is a text message.

13. The system of claim 11, wherein the incoming message includes instructions to change the environmental condition to be monitored.

14. The system of claim 11, wherein the incoming message includes instructions to change the predetermined boundaries.

15. The system of claim 11, wherein the incoming message includes an acknowledgment from the recipient of the alert message.

16. The system of claim 15, wherein the acknowledgement from the recipient prevents transmission of further alarm messages.

17. An alarm system for remotely conveying a deleterious condition of a controlled environment, the alarm system comprising:
a sensor, wherein the sensor is configured to produce a signal which indicates a measured value of an environmental condition in an enclosed room, wherein the enclosed room includes a controlled environment;
a monitoring unit, wherein the monitoring unit:
is located externally to the enclosed room; and
includes:
an electronic display; a control element, wherein the control element is configured to:
allow a user to adjust the environmental condition to be monitored; and
allow a user to adjust the value of predetermined boundaries; and
a keypad, wherein the keypad is configured to allow the user to enter information; and
is configured to:
receive the signal from the sensor;
determine the value of the environmental condition; and
determine whether the value of the environmental condition is outside of the predetermined boundaries; and
an electronic circuit, wherein the electronic circuit is configured to transmit an alert message if the monitoring unit determines the value of the environmental condition exceeds the predetermined boundaries.

18. The system of claim 17, wherein the keypad includes a numeric keypad.

19. The system of claim 17, wherein the keypad allows a user to enter information regarding one of:
the environmental condition to monitor; or
the predetermined boundaries;

20. The system of claim 17, wherein the keypad allows a user to enter information regarding one or more recipients of the alert message.
